(19) United States
(12) Patent Application Publication
(10) Pub. No.: US 2026/0165232 A1
(43) Pub. Date: Jun. 18, 2026

(54) PNEUMATIC FERTILIZER SPREADER AND METHODS FOR CONVEYING DISTRIBUTED MATERIALS

(71) Applicant: HORSCH LEEB Application Systems Gmbh, Landau an der Isar (DE)

(72) Inventor: Manfred KÖBLER, Hemau (DE)

(73) Assignee: HORSCH LEEB Application Systems Gmbh, Landau an der Isar (DE)

(21) Appl. No.: 19/423,694

(22) Filed: Dec. 17, 2025

(30) Foreign Application Priority Data
Dec. 18, 2024 (DE) 10 2024 138 604.5

(51) Int. Cl. A01C 7/20; A01C 7/10; A01C 15/04; G05D 11/13

(52) U.S. Cl. CPC A01C 7/20; A01C 7/10; A01C 15/04; G05D 11/13

(57) ABSTRACT

The invention relates to a pneumatic fertilizer spreader for applying granular material to be spread on agricultural land. The spreader includes a storage container for carrying and/or supplying the material to be spread. The storage container has at least two chambers, each with at least one outlet opening, with the outlet openings being coupled to at least one conveyor device that can be changed by means of a configuration unit. A quantity ratio of material to be spread is stored in the configuration unit, and the configuration unit is configured to operate the at least one conveyor device based on the quantity ratio.

### CROSS-REFERENCE TO RELATED APPLICATIONS

This application claims the benefit of German Patent Application No. DE 10 2024 138 604.5, filed Dec. 18, 2024, the disclosure of which is hereby incorporated herein in its entirety by reference.

### BACKGROUND OF THE INVENTION

### Field of the Invention

The invention generally relates to the field of agricultural spreaders. Specifically, the invention relates to a pneumatic fertilizer spreader for storing and/or dispersing multiple substances simultaneously.

### Background

Fertilizer spreaders are known from the prior art which have a storage container for holding a single fertilizer. This means that only a single fertilizer can be applied to an agricultural area.

### SUMMARY OF THE INVENTION

The object of the invention is therefore to eliminate the disadvantages of the prior art described above. In particular, the aim is to provide a corresponding pneumatic fertilizer spreader by means of which material to be spread can be applied to the agricultural area. Advantageous embodiments and developments of the invention are disclosed in the claims and the following description with reference to the figures.

According to the invention, a pneumatic fertilizer spreader for applying granular material to be spread on agricultural land includes a storage container for carrying and/or supplying the material to be spread. The storage container has at least two chambers, each with at least one outlet opening, wherein the outlet openings are coupled to at least one conveyor device that can be changed by means of a configuration unit, and wherein a quantity ratio of material to be spread can be stored in the configuration unit.

Preferably, it can be provided that the storage container has at least two tapered areas in a lower region, arranged one behind the other in the direction of travel, each of the tapered areas having at least one of the outlet openings.

The provision of tapered areas improves the emptying of the storage container and, in particular, reduces the risk of material to be spread remaining in the tank.

According to a preferred embodiment, it can be provided that the outlet openings are spaced apart from each other in the direction of travel. This allows for improved emptying of the storage container along the length of the storage container in the direction of travel.

Preferably, it can be provided that the tapered areas associated with the outlet openings are coupled to each other. Preferably, the tapered areas are coupled to each other in such a way that the flow of the material to be spread to the respective outlet opening is ensured. This means that the lower area is designed in such a way that the lower area is free of areas in which material to be spread can accumulate and cannot flow to one of the outlet openings.

According to a preferred embodiment, it can be provided that at least one, preferably each, of the tapered areas may have at least one inclined surface which is arranged at an angle, preferably an acute angle, to a horizontal plane. Preferably, the angle is greater than 0°. Preferably, the angle is between 5° and 85°, more preferably 10° to 75°, and more preferably between 15° and 65°, and particularly preferably at least 20°. Alternatively or cumulatively, the inclined surface may have at least one curvature. The provision of at least one inclined surface can improve the flow of the material to be spread.

According to the invention, it is provided that the storage container is provided with at least two chambers. Preferably, material to be spread can be stored in each chamber.

It is preferable for the chambers to be separated from each other. This means that the material to be spread in one chamber cannot mix with material to be spread from other chambers within the storage container, unless a device designed for this purpose is provided. The provision of at least two chambers makes it possible to store different materials and/or to achieve specific emptying of the storage container, for example in order to obtain the best possible weight distribution over the length and/or width of the storage container or fertilizer spreader. For example, positive support loads can always be achieved. Preferably, the configuration unit is designed to coordinate the removal of material to be spread from several chambers, preferably on the basis of a current support load. Preferably, a sensor system is provided which is designed to detect a current support load and to make it available to the configuration unit. Preferably, the configuration unit may be designed to determine the support load based on a weight ratio of the material to be spread in the chambers and the geometry of the fertilizer spreader.

It can be provided particularly preferably that each chamber is assigned at least one of the tapered areas. This allows the material to be spread to be emptied or removed from the respective chamber.

According to a further preferred embodiment, the storage container may be designed so that at least one of the chambers is variable in size. Preferably, partition walls may be provided which are designed to divide the storage container into chambers. Preferably, the partition walls may be fixedly connected to the storage container. Alternatively or cumulatively, the partition walls may be detachably connected to the storage container. This allows the respective partition wall to be removed from the storage container. This allows the geometry of the storage container to be adjusted. Preferably, it may be provided that the storage container and/or the chambers are manually adjustable.

According to the invention, the pneumatic fertilizer spreader is distinguished in that the configuration unit is designed to change the at least one variable conveyor device based on the quantity ratio. Preferably, changing the at least one conveyor device may include open-loop and/or closed-loop control of the at least one conveyor device.

Preferably, the at least one conveyor device is designed to remove material to be spread from the at least two chambers. Furthermore, the at least one conveyor device is preferably designed to convey material to be spread. Preferably, the conveyor device is functionally connected to a distribution linkage of the pneumatic fertilizer spreader and is designed to convey material to be spread in the direction of the distribution linkage.

Preferably, the pneumatic fertilizer spreader comprises a sensor system which is designed to detect the respective quantity of material dispensed. This means that the sensor system detects the quantity actually dispensed from the respective chamber. The sensor system may preferably comprise a weighing system for weighing the material to be spread, preferably for each of the at least two chambers; a fill level measurement system for determining a fill level, preferably for each of the at least two chambers; a flow measurement system for determining a flow of material to be spread, preferably at the respective outlet opening; and/or the like.

Preferably, the pneumatic fertilizer spreader comprises the distribution linkage. The distribution linkage is a distribution linkage extending transversely to a direction of travel, wherein the distribution linkage has several, preferably at least one outlet opening, distribution lines with distribution elements, which distribution lines can be supplied with an air volume flow generated by the flow generation device for conveying the material to be spread.

Preferably, the configuration unit is designed so that the quantity ratio can be specified manually by the user and/or automatically. Preferably, manual user input can be the entry of a specific value for the quantity ratio, for example at a terminal or similar. Alternatively or cumulatively, the quantity ratio can be specified using an application map. Alternatively or cumulatively, a sensor device may be provided which is designed to record information about a crop population and transmit it to the configuration unit, wherein the configuration unit is designed to determine the quantity ratio on the basis of the recorded information about the crop population.

Preferably, the at least one conveyor device is designed to remove material to be spread from the at least two chambers, in particular on the basis of the quantity ratio. The quantity ratio can be used to specify the quantity of material to be spread to be removed from the respective chamber.

Preferably, the at least one conveyor device can be designed as a mechanically and/or pneumatically operating conveyor device. For example, the at least one conveyor device can comprise at least one continuous conveyor, preferably at least one mechanical continuous conveyor and/or at least one pneumatic continuous conveyor.

According to a preferred embodiment, it can be provided that the configuration unit is designed to change the quantity of material to be spread from the respective chambers by changing the at least one variable conveyor based on the quantity ratio.

Depending on the specified quantity ratio, the at least one conveyor device is preferably designed to remove a first quantity of material to be spread from a first chamber and a second quantity of material to be spread from a second chamber. The same applies analogously to any further chambers of the storage container.

Preferably, the removal of material to be spread is based on a quantity of material to be spread that is removed from the respective chamber per unit of time.

Preferably, the at least one conveyor device comprises at least one drive for operating the conveyor device. Preferably, the at least one drive can be an electric, pneumatic and/or hydraulic drive. Preferably, the configuration unit is designed to change the at least one conveyor device by means of a change in the at least one drive.

According to a further preferred embodiment, it can be provided that the at least two chambers are coupled by means of the at least one variable conveyor device in such a way that the materials to be spread from the at least two chambers can be mixed, preferably on the basis of a mixing ratio.

Preferably, the at least one conveyor device is designed to mix the distribution goods of the at least two chambers. This means that the distribution goods taken from the respective chambers can be mixed within the conveyor device. Preferably, the conveyor device is designed to mix the distribution goods taken from the respective chambers. Preferably, the at least one conveyor device is designed so that the respective materials to be spread from the chambers can be mixed in the at least one conveyor device.

Alternatively or cumulatively, the conveyor device is coupled to at least one mixing container and designed to convey the respective material to be spread to the at least one mixing container. Preferably, the at least one mixing container is designed to mix the material to be spread conveyed from the at least one conveyor device to the mixing container.

According to a further preferred embodiment, it can be provided that the same material to be spread and/or different materials to be spread can be supplied in the at least two chambers. By supplying different materials to be spread, it is possible to obtain a mixture, preferably with a mixing ratio, of material to be spread. This makes it possible to respond to different conditions, preferably depending on the crop population and/or the like. By providing the same material to be spread in the chambers, specific emptying of the chambers or the storage container can be achieved, for example, in order to obtain the best possible weight distribution over the length and/or width of the storage container or the fertilizer spreader.

For example, a positive support load can be achieved. Preferably, the configuration unit is designed to coordinate at least one conveyor device for removing the material to be spread from several chambers, preferably on the basis of a current support load. Preferably, a sensor system is provided which is designed to detect a current support load and to make it available to the configuration unit. Preferably, the configuration unit can be designed to determine the current support load based on a weight ratio of the material to be spread in the chambers and the geometry of the fertilizer spreader.

According to a further preferred embodiment, it can be provided that the at least one conveyor device comprises at least one metering device, wherein the metering device is designed to meter material to be spread into distribution lines of a distribution linkage, preferably on the basis of the quantity ratio.

According to a further preferred embodiment, it can be provided that each of the at least two chambers is assigned at least one metering device. Preferably, the respective metering device is designed to metre the material to be spread, preferably from the respective chamber, preferably volumetrically and/or gravimetrically. The respective metering device is designed to remove the material to be spread from the chamber or storage container in a metered manner, preferably with a variable quantity of material to be spread.

According to a further preferred embodiment, it can be provided that a configuration unit is provided which is designed to configure the metering devices on the basis of the quantity ratio and/or a spreading quantity of material to be spread.

Preferably, the configuration unit is designed to configure the respective metering device so that the respective metering device metres a definable quantity of the respective material to be spread from the respective chamber, preferably based on the quantity ratio. Depending on how much material to be spread is to be applied in total and/or how much material to be spread is to be applied from the respective chambers, the configuration unit is designed to configure the respective metering device.

The configuration unit is particularly preferably designed to configure the metering devices in a coordinated manner, preferably on the basis of the quantity ratio and/or the mixing ratio.

The quantity ratio can preferably be used to determine how much material is to be removed from the respective chamber by means of the respective metering device. This can be particularly advantageous if several chambers are filled with the same material. This makes it possible to determine which of the chambers is to be emptied first.

Preferably, the metering devices of each chamber are connected to each other, at least in terms of their function.

Alternatively or cumulatively, it can be provided that a metering device is coupled to at least one mixing container.

Preferably, the at least one metering device can be designed to metre the material to be spread volumetrically and/or gravimetrically.

Preferably, the at least one metering device may be designed as at least one screw conveyor, at least one rotary valve, and/or the like.

According to a further preferred embodiment, it can be provided that the at least one metering device is spatially assigned to the distribution linkage, preferably coupled to the distribution linkage. Spatially associated may mean that the at least one metering device is arranged in a defined and/or definable area around the distribution linkage; and/or that there is a spatial, preferably structural, connection between the metering device and the distribution linkage.

Preferably, the distribution linkage comprises a support device. Preferably, it may be provided that the at least one metering device is coupled to the support device.

According to a preferred embodiment, it can be provided that the distribution linkage comprises a support device, wherein the support device is coupled to a frame of the distribution machine, wherein the support device is designed to be height-adjustable by means of a height adjustment unit.

Preferably, the support device may have a support frame to which the distribution linkage is coupled.

The support frame can be designed such that, for example, a parallelogram and/or a linear unit can be attached. In addition, it would be conceivable that the storage container and/or the conveyor device are also components of the frame.

Preferably, the configuration unit can be designed to change the height of the distribution linkage, i.e. it can be provided in particular that the distribution linkage is height-adjustable to an agricultural area and/or to a crop population. This is achieved in particular by adjusting the height of the distribution linkage in relation to the frame. The height adjustment can be implemented by means of a parallelogram or a linear unit arranged between the frame and the carrier device.

At least one actuator (e.g. one or more hydraulically and/or pneumatically operated linear drives such as cylinders or the like) can be assigned to the parallelogram or the linear unit in order to vary the height distance, i.e. to pivot the parallelogram or to adjust the linear unit.

The parallelogram and/or the linear unit may conveniently be part of the distribution linkage, or in particular the support device may be connected to the parallelogram and/or the linear unit.

According to a further preferred embodiment, it can be provided that the distribution linkage has a linkage centre section which is rotatably coupled to the support device about an axis of rotation oriented in the direction of travel. This allows the distribution linkage to follow forces acting on it.

Preferably, the configuration unit is designed such that the distribution linkage can be configured in terms of its rotational position by means of the rotatable coupling of the distribution linkage to the support device. Preferably, the configuration of the rotational position of the distribution linkage comprises open-loop and/or closed-loop control. Preferably, a sensor device is provided and designed to detect the rotational position of the distribution linkage. Preferably, the configuration unit is designed to perform the configuration of the rotational position on the basis of the detected rotational position.

Preferably, at least one actuator is provided which is coupled to the carrier device and the distribution linkage, and wherein the configuration unit is designed to influence the actuator, preferably on the basis of the rotational position of the distribution linkage.

Preferably, the at least one metering device is coupled to the distribution linkage in such a way that, when the distribution linkage moves, the at least one metering device follows the distribution linkage.

According to a further preferred embodiment, it can be provided that the configuration unit is designed to change the at least one conveyor device based on a definable application rate and/or the actual speed of the fertilizer spreader.

The definable application rate is the amount to be applied to a specific area, expressed in kilograms per hectare. If the application rate changes, correspondingly less material must be removed from the chambers per unit of time.

The actual speed of the fertilizer spreader influences how quickly the material is to be spread on the agricultural area. Since more or less area is covered with material in the same unit of time, the amount of material removed from the chambers must be adjusted accordingly.

Preferably, the definable application rate can be transmitted to the configuration unit by means of a manual user input.

According to a further preferred embodiment, it can be provided that the configuration unit is designed to obtain the quantity ratio of the configuration unit by manual specification, and/or that the configuration unit is designed to automatically change the quantity ratio, preferably on the basis of a site-specific specification and/or a sensor system coupled to the fertilizer spreader.

The site-specific specification may, for example, be understood to mean an application map and/or consideration of the crop population and/or the soil properties. The sensor device is preferably configured to collect information about a crop population and transmit it to the configuration unit, wherein the configuration unit is configured to determine the quantity ratio based on the collected information about the crop population.

According to a further preferred embodiment, it can be provided that the configuration unit is designed to change the quantity ratio based on the actual position of the pneumatic fertilizer spreader.

Preferably, the fertilizer spreader comprises at least one position detection unit which is designed to detect the actual position of the fertilizer spreader on the agricultural area. Preferably, the position detection unit can detect the actual position of the fertilizer spreader using GNSS data, for example GPS, DGPS, Glonass, and/or the like. Alternatively or cumulatively, the position detection unit can detect the actual position of the fertilizer spreader based on RTK data.

Preferably, it can be provided that the configuration unit is designed to change the at least one conveyor device in advance, preferably based on the actual position of the fertilizer spreader. Preferably, it can be provided that the configuration unit is designed to determine the optimal positions for changing the at least one conveyor device.

Preferably, the determination of the optimum positions for changing the at least one conveyor device may be dependent on an actual speed of the fertilizer spreader, an actual position of the fertilizer spreader, the quantity of material to be spread, a conveying time of the material to be spread, the air volume flow generated, and/or the like.

In addition, reaction times can be taken into account, i.e. the time required by the system to make a change to the at least one conveyor device. This may depend on transmission times of corresponding signals, inertia of corresponding actuators and/or the like. By taking reaction times into account, the at least one conveyor device can be adjusted in advance, preferably by means of the configuration unit.

The underlying object is also achieved by a method for operating a pneumatic fertilizer spreader, the method comprising providing a pneumatic fertilizer spreader having a storage container with at least two chambers, each with an outlet opening, each chamber being coupled to at least one conveyor device, and a configuration unit. The method also includes storing a quantity ratio of material to be spread in a configuration unit, and operating the at least one conveyor device on the basis of the quantity ratio via the configuration unit.

In the context of the invention, the respective steps of the method can be carried out in a specified sequence, wherein it is optionally also conceivable, however, that the steps of the method can be carried out in any sequence. Any change between the method steps is also conceivable. In addition, it is also conceivable to supplement the method with further method steps.

Preferably, the steps of the method are carried out continuously and/or at intervals.

The configuration unit comprises, for example, a computer unit, an on-board computer and/or the like and preferably comprises an open-loop and/or closed-loop control circuit, in particular a hydraulic and/or pneumatic and/or electrical open-loop and/or closed-loop control circuit, wherein the open-loop and/or closed-loop control circuit is suitably designed for hydraulic and/or pneumatic and/or electrical signal and/or command transmission. This signal and/or command transmission can also be wireless (e.g. via WLAN).

In the context of the invention, the term “configuration unit” refers in particular to all components for signal and/or command transmission. This also includes computer units, CPUs and/or similar devices. Control devices integrated into the respective sensors or sensor units or sensor arrays are also included. It should also be noted that the signals and/or data from the sensors/measuring devices/detection devices and/or the like can be used as feedback for an open-loop and/or closed-loop controlled variable.

It should also be noted that the terms “configure”, “open-loop control” and “closed-loop control” and “configuration unit” can refer to electronic and/or pneumatic and/or hydraulic open-loop or closed-loop control systems which, depending on their design, can perform open-loop control tasks and/or closed-loop control tasks. Even if the term “configure” is used herein, it may also appropriately include operating via “open-loop control” and/or “closed-loop control”.

To avoid repetition, it should be noted that the embodiments and features of the invention can be combined in any way and freely.

With regard to the advantages and embodiments of the method according to the invention, reference is made to the advantages and embodiments of the pneumatic fertilizer spreader according to the invention.

All features disclosed for the pneumatic fertilizer spreader and the method can be used in a corresponding manner with each other.

For the purposes of the application, features disclosed in conjunction with other features may also be considered to be disclosed on their own. Features linked by “and/or” are to be understood as disclosed on their own and in combination with the other features.

### DESCRIPTION OF THE DRAWINGS

Further details and advantages of the invention are described below with reference to the accompanying drawings. The relative sizes of the individual elements in the figures do not always correspond to the actual sizes, as some shapes are simplified and others are enlarged in relation to other elements for better illustration. In the drawings:

FIG. 1 shows a pneumatic fertilizer spreader in a perspective view;

FIG. 2 shows the fertilizer spreader according to FIG. 1 in a side view;

FIG. 3 shows a detailed representation of a part of the pneumatic fertilizer spreader.

### DETAILED DESCRIPTION OF THE PREFERRED EMBODIMENTS

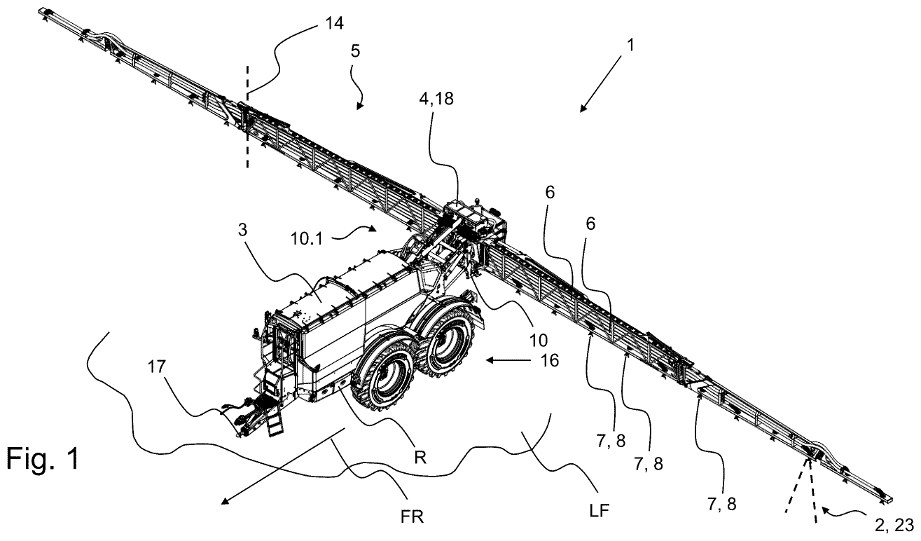

The embodiments shown in FIGS. 1 to 3 correspond at least in part, so that similar or identical parts are provided with the same reference signs and, to avoid repetition, reference is also made to the description of the other embodiments or figures for their explanation.

A variant of a pneumatic fertilizer spreader 1 is shown in the views in the figures. The pneumatic fertilizer spreader 1 can be used in particular to spread, i.e. distribute, granular agricultural materials to be spread in desired quantities on agricultural land LF. The materials to be spread include, for example, agricultural fertilizers and/or microgranules and/or seeds and/or the like.

In the illustrated embodiment, the fertilizer spreader 1 is shown as a fertilizer spreader 1 towed by a towing vehicle (e.g. a tractor not shown here. In other embodiments, the fertilizer spreader 1 can also be designed as a self-propelled fertilizer spreader 1 or as a fertilizer spreader 1 mounted on a towing vehicle. The fertilizer spreader 1 could also be an autonomous vehicle (e.g. fully autonomous or partially autonomous) or be attached to an autonomous carrier vehicle.

The fertilizer spreader 1 comprises a frame R supporting the components of the fertilizer spreader 1, as well as at least one storage container 3 for carrying and/or supplying the material to be spread. Two or more storage containers 3 may also be provided for two or more, in particular different, materials to be spread, i.e. they may be attached to the frame R of the fertilizer spreader 1.

In order to achieve the greatest possible impact, i.e. to achieve a large working width, the fertilizer spreader 1 has a distribution linkage 5 extending transversely to the direction of travel FR over a large working width (e.g. 24 metres, 30 metres, 36 metres or more), wherein the distribution linkage 5 has a support device 10 connected to the frame R, a linkage centre section 11, and booms 13 mounted on the linkage centre section 10 so that they can pivot relative to the linkage centre section 11. Preferably, each boom has at least one linkage section 12, which can be assembled so that it can rotate about vertically oriented axes. The linkage centre section 1 can also be referred to as a linkage section 12.

In order to comply with a permissible transport width (e.g. 3 metres in Germany), the booms 13 are mounted on the linkage centre section 10 so that they can pivot about vertically oriented axes 14.

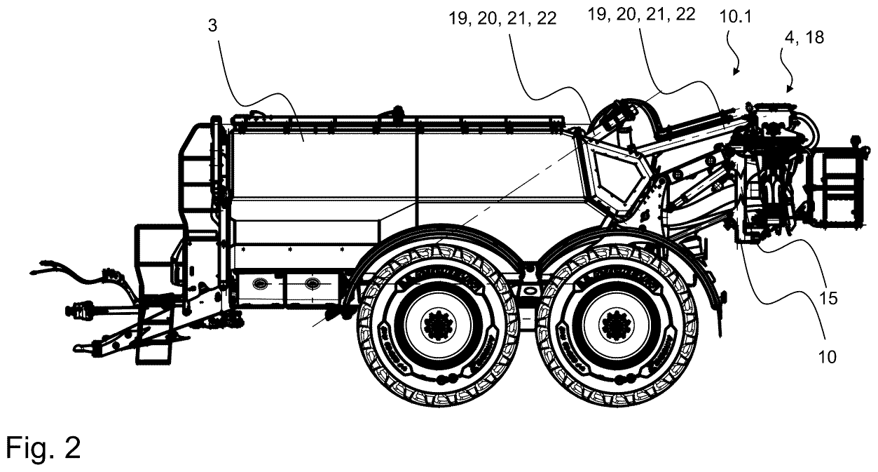

The distribution linkage 5, in particular its linkage centre section 11, is mounted on the support device 10 by means of a bearing 15, which is shown schematically in FIG. 2, transversely to the direction of travel FR and rotatable about an axis of rotation oriented in the direction of travel relative to the frame R. The rotational position can be subject to open-loop and/or closed-loop control in particular by means of an actuating device, which is not shown here, which can be controlled by a control device, wherein the actuating device can be mounted in particular between the middle part 11 of the linkage and the support device 10 and/or between the middle part 11 of the linkage and the frame R.

The frame R can also be advantageously designed in particular as a multi-part structure, wherein the individual parts can in turn be connected by means of a non-detachable connection (e.g. welding) and/or detachable connection (e.g. screws or similar machine elements).

The frame R also comprises a chassis 16 with wheels, which, according to the embodiments, may in particular be a tandem running gear, and a connecting device 17 for connection to a towing vehicle. In addition, the storage container 3 is part of the frame R.

In order to adjust the height of the distribution linkage 5, the support device 10 is mounted on the frame R in such a way that its height can be adjusted by means of a height adjustment device 10.1, for example a parallelogram.

A metering device 4 with a metering container 18 is assigned to the middle section 11 of the distribution linkage 5; in particular, these form a structural unit. A conveyor device 19, which comprises a conveyor line, opens out into the metering container 18, but several conveyor lines and/or conveyor devices 20 could also open out into the metering container 18 in order to be able to feed into it one, two or more different materials to be spread.

Preferably, both the storage container 3 and the metering container 18 taper downwards in a funnel shape, with at least one outlet opening (not shown here) located at the lowest point of each container.

The outlet opening is formed by an opening in the respective container 3, 18, through which, for example, material to be spread is conveyed from the storage container 3 into the conveyor 19 and/or from the metering container 18 into the metering device 4, whereby the outlet opening thus simultaneously forms the inlet of the conveyor 19 and/or the metering device 4.

The material to be spread from the metering device 4 is conveyed to the distribution elements 8 attached to the distribution linkage 5 by means of distribution lines 6 along the distribution linkage 5. During operation of the fertilizer spreader 1, the material to be spread is conveyed along the distribution lines 6 by means of an air volume flow, wherein the distribution lines 6 are coupled to a flow generation device (e.g. one or more blowers such as centrifugal blowers, radial blowers, axial blowers, diagonal blowers, cross-flow blowers or the like) for this purpose, i.e. they are operatively connected.

A plurality of distribution lines 6 are attached along the distribution rod 5, to each of which a distribution element 8 is attached in accordance with the exemplary embodiments, however, two or more distribution elements 8 per distribution line 6 would also be conceivable or possible, wherein, according to the figures, each distribution line 6 has a distribution element 8 which is assigned to the respective outer end of the distribution line 6, which forms an outlet opening 7. The distribution lines 6 also have different lengths starting from the metering device 4, i.e. they extend in different lengths from the metering device 4 along the distribution linkage 5.

In order to achieve a compact distribution linkage 5, the distribution lines 6 are also arranged one above the other, i.e. a plurality of distribution lines 6 are arranged one above the other.

The distribution lines 6 are also attached to the distribution linkage 5 in a substantially symmetrical manner with respect to the linkage centre section 11. In addition, the respective opposing distribution elements 8 each have at least largely the same height position.

The distribution lines 6 also have separation points, not shown here, between the linkage centre section 11 and the booms 13 or between the linkage sections 12 of the boom 13.

The distribution elements 8 can be formed in particular by impact plates, against which the material to be spread is conveyed by means of the air volume flow and then spread, for example, in a fan-shaped pattern by means of the impact plate, depending on how the impact plate is designed. However, the distribution elements 8 can also be formed by an arcuate end region of the distribution lines 6, which can thus act as impact plates, for example.

The distances between the distribution elements 8 can be such that the spreading fans generated by the distribution elements 8 enable the material to be spread over the entire surface, in particular enabling the material to be spread without gaps.

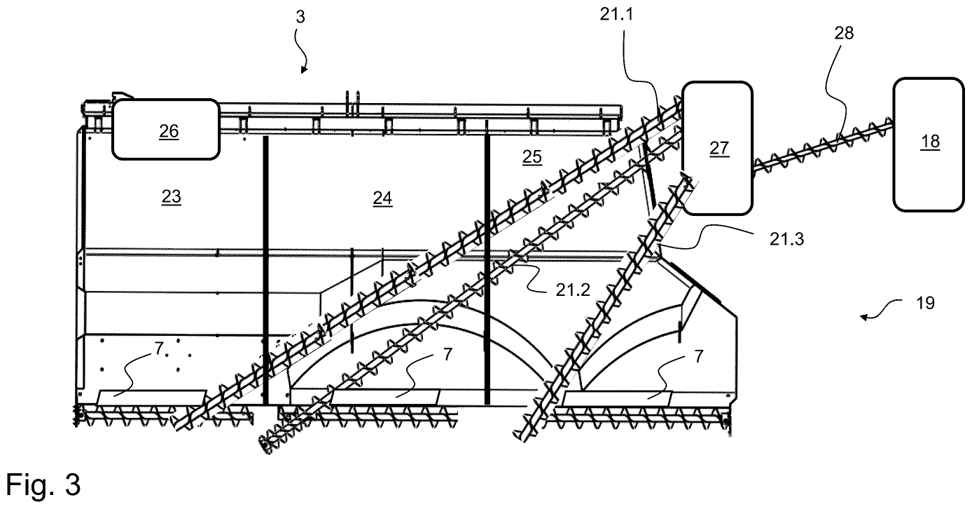

According to an alternative variant, it would also be conceivable for the distribution elements 8 to be arranged on the distribution linkage 5 in such a way, or for the spreading fans generated by the distribution elements 8 to be such, that the spreading fans overlap. For example, a double or triple overlap of the spreading fans can be provided, which in turn can increase the distribution quality, as shown in FIG. 3.

In order to supply the metering device 4 with the respective material to be spread, it is operatively connected to at least one storage container 3, wherein the operative connection can be made by means of a conveyor device 19 with, for example, a conveyor line 20 and by means of the metering container 18.

The conveyor device 19 according to the exemplary embodiments comprises a conveyor line 20 or conveyor device 20 opening into the metering container 18, but two or more conveyor lines 20 could also be provided, in particular for different materials to be spread.

The conveyor device 19 or conveyor line 20 is divided into at least two parts, i.e. it has several conveyor sections 21, 22.

The conveyor device 19 and/or the conveyor sections 21, 22 may be formed by one or more screw conveyors and/or conveyor belts and/or the like.

Alternatively or additionally, the conveyor device 19 can also be formed, at least in sections, by a pneumatic conveyor device, in which the material to be spread is conveyed along the conveyor line 20 by means of an air volume flow.

The metering device 4 is assigned to the linkage centre section 11 and/or the carrier device 10 in such a way that it follows the vertical movements and/or the rotational movements of the distribution linkage 5 at least largely synchronously.

It is preferable that the pneumatic fertilizer spreader 1 comprises at least a frame R supporting components of the fertilizer spreader 1, a storage container 3 for carrying and supplying the material to be spread (e.g. seed, fertilizer and/or the like), a distribution linkage 5 extending transversely to the direction of travel FR, which distribution linkage 5 has a carrier device 10 a linkage centre section 11 and booms 13 rotatably attached to the linkage centre section 11, wherein distribution lines 6 with distribution elements 8 and a metering container 18 operatively connected to the storage container 3 by means of the conveyor device 19 are attached to the distribution linkage 5, wherein, in order to convey the material to be spread along the distribution lines 6 to the distribution elements 8, the distribution lines 6 can be supplied with an air volume flow, and wherein, by means of at least one metering device 4 forming a structural unit with the distribution linkage 5 and operatively connected to the metering container 18, material to be spread can be metered into the distribution lines 6.

FIG. 3 shows a schematic representation of part of the fertilizer spreader 1 according to the invention, wherein the storage container 3 has at least two chambers 23, 24, 25, in this case three chambers 23, 24, 25. Each of the chambers 23, 24, 25 has at least one outlet opening 7, which is shown schematically in FIG. 7.

The outlet openings 7 of the chambers 23, 24, 25 are coupled to the conveyor device 19. According to the invention, it is provided that the conveyor device 19 can be varied by means of a configuration unit 26 on the basis of a quantity ratio. The quantity ratio describes how much of the material to be spread is to be removed from each of the chambers 23, 24, 25 and conveyed, so that the respective quantities from each of the chambers 23, 24, 25 describe the quantity ratio. Since the quantity ratio can change, for example due to a change in the output quantity, i.e. the total quantity to be dispensed, the composition of the quantity to be delivered, a changing crop population, and/or the like, the configuration unit 26 is designed to change the conveyor device 19.

In the present case, the at least one conveyor device has three conveyor sections 21.1, 21.2, 21.3, each of the conveyor sections 21.1, 21.2, 21.3 is coupled to one of the chambers 23, 24, 25, in particular the outlet opening 7, and is designed to convey the material to be spread from the chamber 23, 24, 25. In the present case, each of the three conveyor sections 21.1, 21.2, 21.3 is designed as a screw conveyor.

In the present case, it is provided that the conveyor sections 21.1, 21.2, 21.3 are coupled to a mixing chamber 27 and are designed to convey the material to be spread into the mixing chamber 27. In the present case, the mixing chamber 27 is a separate container, but can also be formed by the metering container 18.

Preferably, the mixing chamber 27 is designed to mix the material to be spread conveyed by the conveyor sections 21.1, 21.2, 21.3.

A conveyor unit 28 is also provided, which is designed to convey the mixed material to be spread from the mixing chamber 27 to the metering container 18. If the metering container 18 is also the mixing chamber 27, the conveyor unit 28 is not required.

Although the invention has been described with reference to specific exemplary embodiments, it will be apparent to those skilled in the art that various modifications may be made and equivalents may be substituted without departing from the scope of the invention. In addition, many modifications may be made without departing from the scope of the invention. Consequently, the invention should not be limited to the disclosed exemplary embodiments, but should encompass all exemplary embodiments falling within the scope of the appended claims. In particular, the invention also claims protection for the subject matter and features of the dependent claims independently of the claims referred to.

1. A pneumatic fertilizer spreader for applying granular material to be spread on agricultural land, at least comprising a storage container for carrying and/or supplying the material to be spread, wherein:
the storage container has at least two chambers, each with at least one outlet opening;
the outlet openings are coupled to at least one variable conveyor device that can be changed by a configuration unit;
a quantity ratio of material to be spread can be stored in the configuration unit; and
the configuration unit is configured to operate the at least one variable conveyor device based on the quantity ratio.

2. The pneumatic fertilizer spreader according to claim 1, wherein the configuration unit is configured to change a quantity of material to be spread from the respective chambers based on the quantity ratio by changing the operation of the at least one variable conveyor device.

3. The pneumatic fertilizer spreader according to claim 1, wherein the at least two chambers are coupled by the at least one variable conveyor device such that the materials dispensed from each of the at least two chambers are at least partially mixed together.

4. The pneumatic fertilizer spreader according to claim 1, wherein a different material is contained within each of the at least two chambers.

5. The pneumatic fertilizer spreader according to claim 1, wherein the at least one variable conveyor device comprises at least one metering device, and wherein the metering device is configured to meter material to be spread into distribution lines of a distribution linkage.

6. The pneumatic fertilizer spreader according to claim 5, wherein the at least one metering device is coupled to the distribution linkage.

7. The pneumatic fertilizer spreader according to claim 5, wherein:
the distribution linkage comprises a support device;
the support device is coupled to a frame of the fertilizer spreader; and
the support device is designed to be height-adjustable by a height adjustment unit.

8. The pneumatic fertilizer spreader according to claim 7, wherein the distribution linkage has a linkage center section which is rotatably coupled to the support device about an axis of rotation oriented along a direction of travel.

9. The pneumatic fertilizer spreader according to claim 1, wherein the configuration unit is configured to change the at least one variable conveyor device based on a definable application rate and/or an actual speed of the fertilizer spreader.

10. The pneumatic fertilizer spreader according to claim 1, wherein the quantity ratio is stored in the configuration unit by manual specification.

11. The pneumatic fertilizer spreader according to claim 1, wherein the configuration unit is configured to change the quantity ratio based on an actual position of the pneumatic fertilizer spreader.

12. The pneumatic fertilizer spreader according to claim 5, wherein the metering device is configured to meter material to be spread into the distribution lines of the distribution linkage. on the basis of the quantity ratio.

13. The pneumatic fertilizer spreader according to claim 1, wherein the configuration unit is configured to automatically change the quantity ratio based on at least one of a site-specific specification and an output from a sensor system coupled to the fertilizer spreader.

14. A method for conveying material to be spread, comprising the method steps of:
providing a pneumatic fertilizer spreader comprising a storage container with at least two chambers, each with an outlet opening, each chamber being coupled to at least one conveyor device, and a configuration unit;
storing a quantity ratio of material to be spread in the configuration unit;
operating the at least one conveyor device, based on the quantity ratio, by via the configuration unit.
